(19) United States
(12) Patent Application Publication
(10) Pub. No.: US 2024/0310286 A1
(43) Pub. Date: Sep. 19, 2024

(54) ORDERED NANOTREES FOR SENSING APPLICATIONS

(71) Applicant: International Business Machines Corporation, Armonk, NY (US)

(72) Inventors: Daniel Schmidt, Niskayuna, NY (US); Stefan Schoeche, Lincoln, NE (US)

(21) Appl. No.: 18/182,411

(22) Filed: Mar. 13, 2023

(51) Int. Cl. G01N 21/65

(52) U.S. Cl. CPC G01N 21/658; B82Y 10/00; B82Y 20/00; B82Y 40/00

(57) ABSTRACT

Embodiments are disclosed for a sensing device and a method for fabrication. The sensing device includes a substrate and an array of ordered nanotrees in contact with the substrate. The array of ordered nanotrees includes multiple trunk sections having multiple predetermined trunk thicknesses, and multiple branches. The branches include multiple predetermined widths in two dimensions. Additionally, the branches include multiple predetermined branch thicknesses. Further, the array of ordered nanotrees is configured to perform a sensing application based on an interaction between a sensing source and the array of ordered nanotrees. Additionally, the array of ordered nanotrees includes multiple predetermined distances between branches of neighboring ordered nanotrees.

### BACKGROUND

The present disclosure relates to ordered nanotrees, and more specifically, to ordered nanotrees for sensing applications.

Sensing applications can refer to the use of technology to make determinations based on sensory information regarding physical, chemical, or other features of an object, environment, and the like. Accordingly, an apparatus to perform sensing applications may be useful.

### SUMMARY

Embodiments are disclosed for a sensing device and a method for fabrication. The sensing device includes a substrate and an array of ordered nanotrees in contact with the substrate. The array of ordered nanotrees includes multiple trunk sections having multiple predetermined trunk thicknesses, and multiple branches. The branches include multiple predetermined widths in two dimensions. Additionally, the branches include multiple predetermined branch thicknesses. Further, the array of ordered nanotrees is configured to perform a sensing application based on an interaction between a sensing source and the array of ordered nanotrees. Additionally, the array of ordered nanotrees includes multiple predetermined distances between branches of neighboring ordered nanotrees.

The present summary is not intended to illustrate each aspect of every implementation of, and/or every embodiment of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a set of vertical cross-section views of example fabrication states of ordered nanotrees for sensing applications, in accordance with some embodiments of the present disclosure.

FIGS. 2A, 2B are vertical cross-section views of ordered nanotrees for sensing applications, in accordance with some embodiments of the present disclosure.

FIG. 3 is a vertical cross-section view of example fabrication states for fabricating ordered nanotrees for sensing applications, in accordance with some embodiments of the present disclosure.

FIGS. 4A, 4B, 4C are overhead views of layouts of ordered nanotrees on wafers, in accordance with some embodiments of the present disclosure.

FIGS. 5A, 5B are side perspectives of ordered nanotrees for sensing applications, in accordance with some embodiments of the present disclosure.

FIG. 6 is a vertical cross-section view of ordered nanotrees for sensing applications, in accordance with some embodiments of the present disclosure.

FIG. 7 is a vertical cross-section view of ordered nanotrees for sensing applications, in accordance with some embodiments of the present disclosure.

FIG. 8 is a vertical cross-section view of ordered nanotrees for sensing applications, in accordance with some embodiments of the present disclosure.

FIGS. 9A, 9B are vertical cross-section views of ordered nanotrees for sensing applications, in accordance with some embodiments of the present disclosure.

FIG. 10 is a diagram of an example sensing application using an example ordered nanotree, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the embodiments described. On the contrary, the intention is to cover all modifications, equivalents, and alternatives falling within the spirit and scope of the present disclosure.

### DETAILED DESCRIPTION

As stated previously, an apparatus to perform sensing applications may be useful. For example, sensing applications can include biological and chemical applications such as viral and bacterial detection. Additionally, sensing applications can include photonics and plasmonics applications such as, ellipsometry, scatterometry, Raman scattering, and the like. Photonics refers to a technology that deals with photons, specifically, their properties and transmission (e.g., in fiber optics). Plasmonics, also referred to as nanoplasmonics, are techniques for generating, detecting, and/or manipulating signals at optical frequencies. The generation, detection, and manipulation occur along metal-dielectric interfaces in the nanometer scale. Ellipsometry refers to an optical technique for analyzing thin film dielectric properties. This technique measures changes in polarization after reflection and/or transmission. Scatterometry refers to a technique for characterizing unknown properties. This technique involves measuring broadband light reflected from the object. Such reflection can vary in various factors such as, wavelength, polarization, and/or angle-of-incidence. Raman refers to a technique for scattering light. More specifically, in Raman, a molecule scatters incident light from a source such as, a relatively high intensity laser light. Raman scattering can include surface enhanced Raman spectroscopy (SERS), which provides selective detection of molecules using laser light. More specifically, surface enhanced Raman scattering can use tailored surface dimensions to enhance the signal for characteristic photons resulting from plasmonic field effects.

Accordingly, some embodiments of the present disclosure provide methods for forming nanotrees of ordered, three-dimensional structures, capable of serving as sensing templates, and having an engineered response in three dimensions for optical sensing techniques such as, SERS. Additionally, such nanotrees can provide optical metamaterials (e.g., metal nanotrees that excite a plasmonic resonance). Advantageously, the methods for forming such nanotrees can be reproducible, mass-manufacturable, and possible using standard semiconductor manufacturing techniques. Further, such methods can fabricate the branches and trunks of these nanotrees to specific lengths and thicknesses in three dimensions. Additionally, such methods can generate these nanotrees with specific distances between their branches.

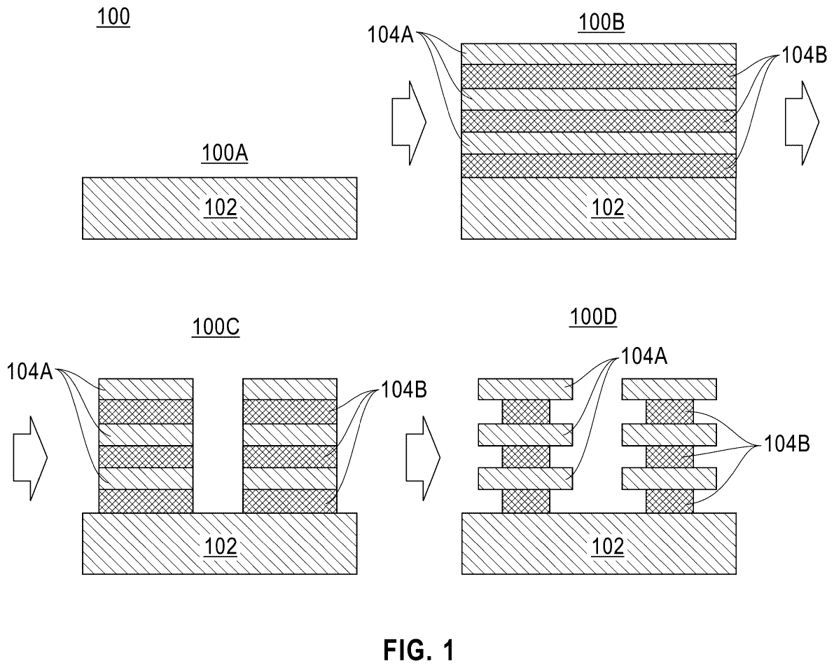

FIG. 1 is an example fabrication process 100 consisting of vertical cross-section views representing example fabrication states 100A, 100B, 100C, 100D of ordered nanotrees for sensing applications, in accordance with some embodiments of the present disclosure. The example fabrication process 100 includes example fabrication states 100A, 100B, 100C, 100D, with arrows indicating the progression of the fabrication from example fabrication state 100A to example fabrication state 100D. According to some embodiments of the present disclosure, the example fabrication states represent a technique that can shape layers of nanosheet films into tree-like structures having a trunk and branches (e.g., nanotrees). Further, such embodiments can control the shape of these nanotrees. Fabricating such shapes can include controlling the lengths and widths of the branches and/or trunks, and the distances between branches in three-dimensional space.

For example, the example fabrication state 100A can represent an initial state of fabrication including a substrate 102 (e.g., silicon (Si)). The right-pointing arrow indicates example fabrication state 100B, which represents a state of fabrication after depositing alternating nanosheet layers 104A, 104B. For example, fabricating the alternating nanosheet layers 104A, 104B can involve alternating epitaxial growth of their materials, with controlled thickness. According to some embodiments of the present disclosure, the nanosheet layers 104A, 104B can have different etch properties, which means that when applying a chemical etch process to these layers, each layer will be etched to a different length. For example, the nanosheet layers 104A, 104B can include silicon and/or silicon compounds such as, silicon-germanium (SiGe), silicon-oxide (SiOx), silicon-nitride (SiN), and the like. Thus, depending on the concentration of the different compounds of the material in each layer, the etch property may vary. According to some embodiments of the present disclosure, these concentrations may be based on a predetermined shape of the ordered nanotrees 106. Thus, performing a single chemical etch can indent the alternating nanosheet layers 104A, 104B selectively.

The right-pointing arrow to the right of example fabrication state 100B indicates example fabrication state 100C. More specifically, example fabrication state 100C represents a state of fabrication after performing lithography and etching to pattern nanosheet stacks consisting of the nanosheet layers 104A, 104B. Lithography can involve drawing circuit patterns. Further, etching may involve wet or dry etching. The right-pointing arrow indicates example fabrication state 100D.

The example fabrication state 100D represents a state of fabrication after performing a partial etch of nanosheet layer 104B. Accordingly, some embodiments of the present disclosure can form ordered nanotrees 106, with etched layers (nanosheet layers 104B) representing a trunk of the nanotrees, and the non-etched layers (nanosheet layers 104A) representing branches of the nanotrees.

While the example fabrication state 100D may include branches of equal length, and 6 layers, some embodiments of the present disclosure can fabricate ordered nanotrees 106 with branches and trunks of varying length. Further, some embodiments of the present disclosure can include more than the 6 layers shown here.

More specifically, the alternating nanosheet layers 104A, 104B can include different concentrations of the silicon and other materials. Accordingly, performing a single chemical etch on the nanosheet layers may produce nanotrees of predetermined lengths, widths, and thicknesses in three dimensions.

Further, the amount of the specific material in each layer can determine the width of the etched layers of the ordered nanotrees. For example, manipulating the ratio of germanium to silicon in a nanosheet layer 104A, 104B, can change the amount of material removed during a chemical etching process. In this way, some embodiments of the present disclosure can fabricate the branches and trunks of the nanotrees 106 to specific lengths and widths in three dimensions.

Further, some embodiments of the present disclosure can form an array of ordered three-dimensional nanotree structures, which include a variable number of branches trunk sections having variable lengths. Such arrays can range from lines and spaces to cylindrical pillars. Additionally, these nanotree structures may be coated with a plasmonic metal, for example, or used as mold to form plasmonic metallic inverse structures.

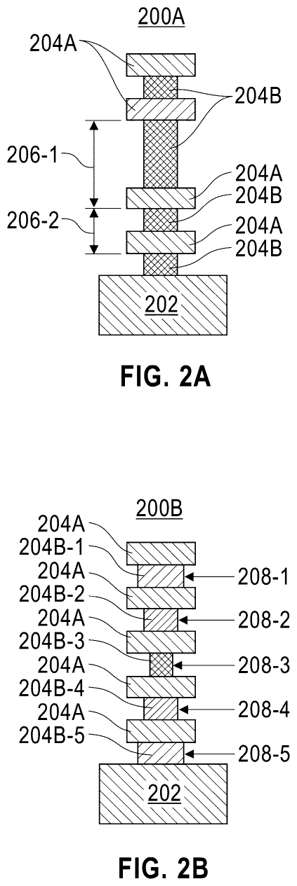

FIG. 2A is a vertical cross-section view of an example ordered nanotree 200A for sensing applications, in accordance with some embodiments of the present disclosure. The example ordered nanotree 200A includes a substrate 202, branches 204A, and trunk sections 204B, 204B, 204B, 204B. The example ordered nanotree 200A illustrates trunk sections 204B of varying thickness. As shown, the out of plane pitch 206-1 is less than the out of plane pitch 206-2, as a result of the varied thickness of trunk section 204B-2 and trunk section 204B-3, respectively. According to some embodiments of the present disclosure, the thickness of the trunk sections 204B can be varied by varying the amount of material in the nanosheet layer of the corresponding trunk section. In this way, some embodiments of the present disclosure can determine the out of plane pitch of the trunk sections 204B of the ordered nanotree 200A. This thickness can determine the pitch along the z-axis (out of plane). Further, some embodiments may use, for in-plane patterning, optical or extreme ultraviolet (EUV) lithography to generate relatively small in-plane pitches (e.g., comparable to a typical fin patterning process). Alternatively, some embodiments may use self-aligned multiple patterning (SAxP), (e.g., x=D, Q). As EUV lithography is more expensive than optical lithography, self-aligned double/quadruple patterning (SA[D/Q]P) can be useful for a 2× or 4× pitch reduction. In this way, it is possible to achieve sub-resolution features. For example, it is possible to use optical lithography to get to EUV SE pitches.

FIG. 2B is a vertical cross-section view of an example ordered nanotree 200B for sensing applications, in accordance with some embodiments of the present disclosure. The example ordered nanotree 200B includes a substrate 202, branches, 204A, and trunk sections 204B-1, 204B-2, 204B-3, 204B-4, 204B-5. According to some embodiments of the present disclosure, the width of the trunk sections 204B can be varied by varying the amount of germanium in the corresponding nanosheet layers. In other words, the percentage of germanium determines the etch depth, and thus, the lengths of branches and/or trunk sections. For example, trunk sections 204B-1, 204B-5 can each include 15% germanium; trunk sections 204B-2, 204B-4 can include 20% germanium; and, trunk section 204B-3 can include 25% germanium. Accordingly, etching of the nanosheet layers corresponding to the trunk sections 204B can result in trunk sections 204B of varying width. Thus, as the amount of germanium increases, the width of the trunk sections 204B decrease. In this example, the width of trunk section 204B-3, having 25% germanium is smaller than the widths of trunk sections 204B-2, 204B-4, having 20% germanium, which are smaller than the widths of trunk sections 204B-1, 204B-5, having 15% germanium. Further, similar amounts of germanium result in similar widths. For example, the widths of: trunk sections 204B-1, 204B-5 (having 15% germanium) are equal; and, trunk sections 204B-2, 204B-4 (having 20% germanium) are equal. In this example, the indentations of the trunk sections 204B-1, 204B-2, 204B-3, 204B-4, 204B-5 are indicated by lines 208-1, 208-2, 208-3, 208-4, 208-5, respectively,

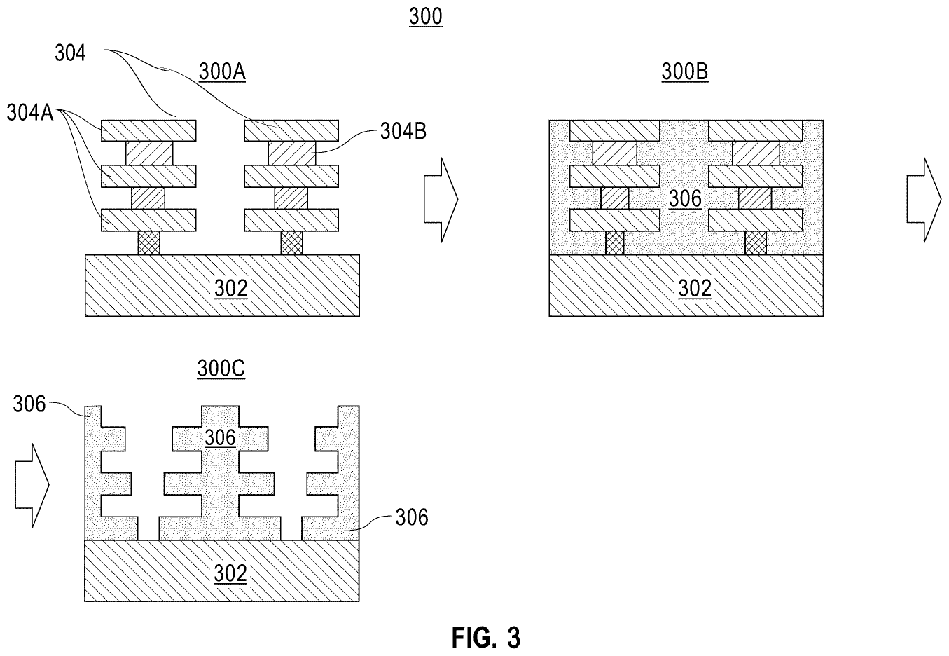

FIG. 3 is a vertical cross-section view of example fabrication states for fabricating ordered nanotrees for sensing applications, in accordance with some embodiments of the present disclosure. According to some embodiments of the present disclosure, the ordered nanotrees, fabricated as described with respect to FIG. 1, can be used as templates for an inverse structure of the fabricated nanotree. More specifically, such embodiments can fabricate these inverse structures by performing a template fill, chemical-mechanical planarization (CMP), and removal of the alternating nanosheet layers (e.g., nanosheet layers 104A, 104B). This template fill, CMP, and removal are represented in example fabrication states 300A, 300B, 300C, in a sequence indicated by right-pointing arrows in rightward correspondence between the example fabrication states.

In example fabrication state 300A, a substrate 302 having nanotrees 304. The nanotrees 304 are similar to the ordered nanotrees 204 described with respect to FIG. 2 and includes alternating nanosheet layers 304A, 304B, similar to the alternating nanosheet layers 104A, 104B. The rightward arrow indicates example fabrication state 300B.

The example fabrication state 300B is similar to example fabrication state 300A, and represents the template fill and CMP, described above. The example fabrication state 300B, thus, additionally includes a fill 306. The fill 306 can be a metal (e.g., copper) and/or other metals (and/or other dielectrics). The corresponding rightward arrow indicates example fabrication state 300C.

The example fabrication state 300C is similar to example fabrication state 300B, and represents the removal, referenced above. The removal can involve selectively removing (e.g., the original film stack) that serves as a scaffolding template (e.g., a mold) for the template fill 306. The template fill 306 can serve as an apparatus that is useful for optical sensing (e.g., for plasmonic applications). Further, because the ordered nanotrees 304 are fabricated to specific, lengths, which may vary in three dimensions, the resulting structure of the template fill 306 may correspondingly vary in three dimensions. Accordingly, the ordered nanotrees 304 can be used in optical sensing and plasmonic applications because the width of the branches and trunk sections, distance between the branches, and thicknesses of the branches and trunks are predetermined, and selectively controlled by the composition of the alternating nanosheet layers comprising the original film stack.

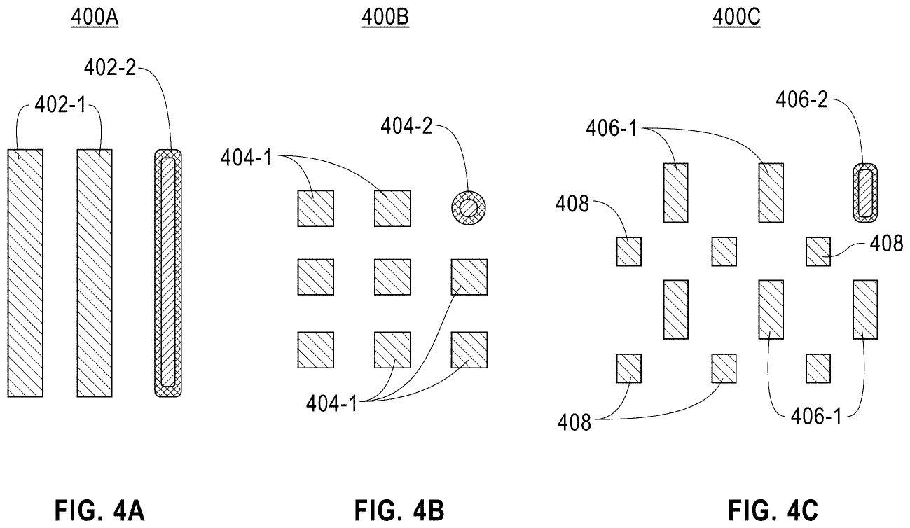

FIGS. 4A, 4B, 4C are overhead views of example layouts 400A, 400B, 400C of ordered nanotrees on wafers, in accordance with some embodiments of the present disclosure. Some embodiments of the present disclosure can fabricate ordered nanotrees on silicon wafers, arranged in similar layouts to semiconductor chips. As stated previously, fabrication of ordered nanotrees includes a patterning process. This patterning process can produce nanosheet stacks in predetermined patterns, such as shown in example layouts 400A, 400B, 400C. For example, in the example layout 400A, the ordered nanotrees 402-1, 402-2 are arranged in a line space arrangement, where the lines represent rows of ordered nanotrees, similar to gate rows on semiconductor chips. The ordered nanotrees 402-1 can represent design shapes (e.g., a line/space pattern on a lithography mask/reticle). Additionally, the ordered nanotrees 402-2 can represent the formed nanotrees (e.g., the branches are formed, and corners are rounded due to processing).

In the example layout 400B, the ordered nanotrees 404-1, 404-2 are arranged in a contact-hole array, similarly to a contact-via arrangement on a semiconductor chip. In the contact-hole array, each shape can represent an ordered nanotree. More specifically, the ordered nanotrees 404-1 can represent design shapes. Additionally, the ordered nanotrees 402-2 can represent the formed nanotrees.

In the example layout 400C, the ordered nanotrees 406-1, 406-2, 408 can be configured for in-plane anisotropy, where the nanotrees are arranged similarly to the layout of contacts to gates and source/drain (S/D) on a semiconductor chip. In this comparison, the ordered nanotrees 406-1, 406-2 represent the relative positions of the S/D contacts; and, the ordered nanotrees 408 can represent the relative positions of the gate contacts. Similar to the ordered nanotrees 402-1, 404-1, the ordered nanotrees 406-1 can represent design shapes. Similar to the ordered nanotrees 402-2, 404-2, the ordered nanotrees 406-1 can represent the formed nanotrees. In this way, the example layout 400C may be useful for in-plane anisotropy by increasing the sensitivity of optical sensing.

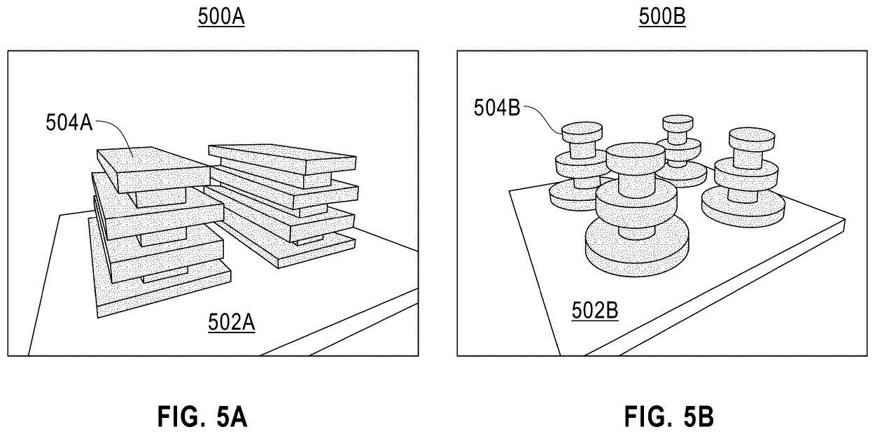

FIGS. 5A, 5B are three-dimensional (3D) side perspectives of ordered nanotrees 504A, 504B for sensing applications, in accordance with some embodiments of the present disclosure. The ordered nanotrees 504A, 504B can be similar to the ordered nanotree 106, described with respect to FIG. 1. Referring back to FIG. 5A, two ordered nanotrees 504A are arranged in rows on a substrate 502A. The layout of the ordered nanotrees 504A can be similar to the example layout 400A. The substrate 502A can be similar to the substrate 102. In FIG. 5B, four ordered nanotrees 504B are located in two rows and columns on the substrate 502B. Accordingly, the ordered nanotrees 504B can have a layout similar to the contact-hole arrangement (e.g., example layout 400B).

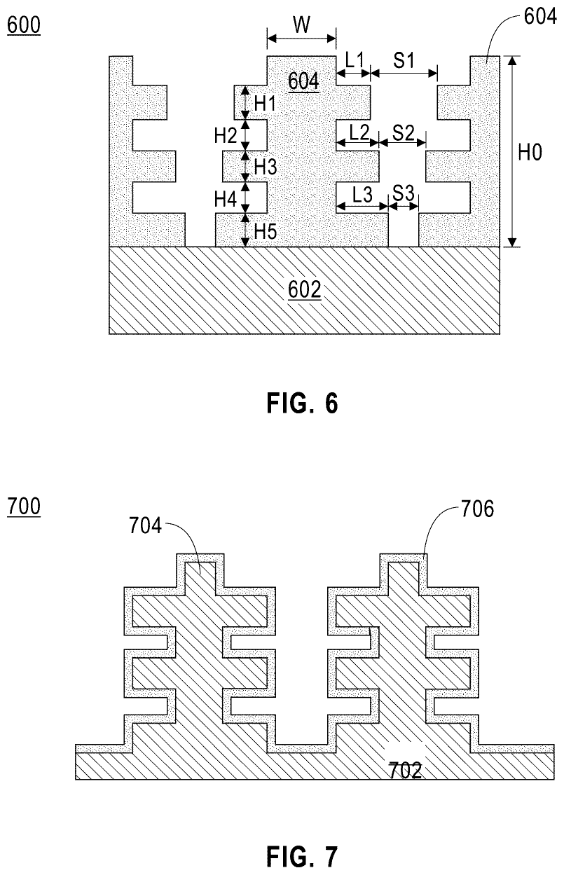

FIG. 6 is a vertical cross-section view of an example ordered nanotree template 600 for sensing applications, in accordance with some embodiments of the present disclosure. The example nanotree template 600 includes a substrate 602 and an example ordered nanotree 604 with partial representations of neighboring ordered nanotrees. The example ordered nanotree 604 can be composed of a single material, such as the template fill 406, described with respect to FIG. 4. The substrate 602 can be similar to the substrate 402.

As shown in FIG. 6, the example nanotree 604 is configured to specific sizes in the x and y planes. More specifically, the trunk of the example ordered nanotree 604 has a width W in the x direction, as indicated by the accompanying symbols. As stated previously, the ordered nanotrees 604 are fabricated with these widths and thicknesses based on the material composition (e.g., etch properties indicate trunk and branch lengths) and the nanolayer deposition, which indicate the thickness of each nanosheet layer.

Additionally, the out-of-plane pitch (e.g., height) H0, represents the height of the ordered nanotrees. Additionally, the out-of-plane pitches H1, H3, H5 represent the thicknesses (e.g., in the y, or out of plane, direction) of the ordered nanotree branches. Further, the heights H2, H4 represent the distances between these branches in the y direction.

Additionally, the lengths L1, L2, L3 indicate the lengths of the branches in the x direction. Further, the spaces S1, S2, S3 indicate the distances between the branches of neighboring nanotrees in the x direction.

According to some embodiments of the present disclosure, ordered nanotrees 604 can be fabricated to specific heights, lengths, and spaces, as described above, by creating the nanotrees that served as the template for the nanotree 604 in a corresponding shape. More specifically, the template nanotrees may be fabricated to the heights, lengths, and spaces that correspond to the heights H1, H2, H3, H4, H5, lengths L1, 12, L3, and spaces S1, S2, S3 of the nanotree 604.

FIG. 7 is a vertical cross-section view of ordered nanotrees 704 for sensing applications, in accordance with some embodiments of the present disclosure. As stated previously, the ordered nanotrees 704 may be fabricated by multilayer stacking of nanosheets having silicon and/or silicon-germanium. Alternatively, fabrication of the ordered nanotrees 704 can involve molding in the shape of the ordered nanotrees. In such embodiments, the ordered nanotrees 704 can be composed of numerous different materials. Additionally, fabrication can involve a functional surface modification. In other words, the ordered nanotrees are coated with a material using atomic layer deposition. In this way, the deposited material can uniformly coat each branch and trunk section of the ordered nanotrees. In this way, the coated material can provide a predetermined functionality, for example, based on a property of the material. For example, coated materials can include any material that can be conformally coated with atomic layer deposition such as: oxides (AL2O3, HfO2, TiO2, SiO2), nitrides (GaN, TaN, HIN), fluorides (MgF2, AlF3), sulfides (ZnS, MoS2), and metals (Pt, Ru, Pd, Ni, W). These materials are merely examples of potential functional coatings. Other materials that can be conformally coated with atomic layer deposition may also be used.

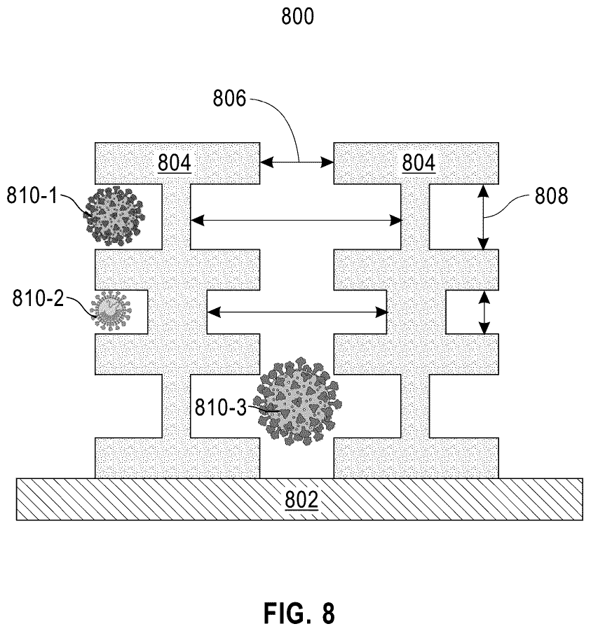

FIG. 8 is a vertical cross-section view of ordered nanotrees 804 for sensing applications, in accordance with some embodiments of the present disclosure. As stated previously, ordered nanotrees can be useful for biological applications, such as detecting viruses or other biomolecules. According to some embodiments of the present disclosure, the dimensions of the ordered nanotrees, in and out of plane, can be configured for single or multiple species trapping. In this example, the ordered nanotrees 804, with specific dimensions (e.g., indicated by arrows 806 [in plane] and arrows 808 [out of plane]) are fabricated on a substrate 802. Accordingly, the ordered nanotrees 804 can capture multiple species (e.g., viruses 810-1, 810-2, 810-3) of various sizes. Alternatively, such configurations can be useful for capturing multiple species of bacteria, molecules, and the like. Accordingly, it can be possible to detect the trapped biomolecules optically. Similarly, with respect to electric field enhancements, the dimensions of the ordered nanotrees can be configured for multiple resonances.

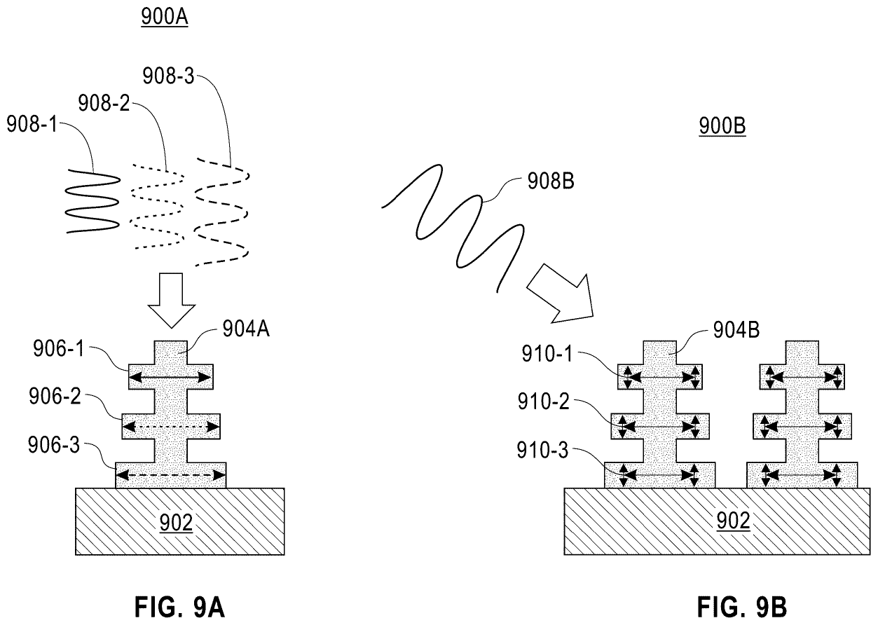

FIG. 9A is a diagram of an example sensing application using an ordered nanotree 904A for SERS, in accordance with some embodiments of the present disclosure. With respect to SERS, some embodiments of the present disclosure can provide relatively strong electric field localization in sub-wavelength metallic features, which increases Raman scattering. Further, the specifically tailored branch lengths can create different plasmonic modes to amplify specific wavelengths, and provide improved selectivity of such wavelengths. With respect to ellipsometry or reflectometry, some embodiments of the present disclosure can enable different plasmonic resonances to be excited depending on the polarization and angle of incidence of the probing light source (e.g., laser beam). In this way, such embodiments can provide a 3D parameter-space to explore for improved sensing conditions. In such embodiments, a light source directed from a normal incidence (e.g., 90-degree angle with respect to the branches of the ordered nanotrees), the in-plane modes may be excited (e.g., within the branches).

For example, the ordered nanotree 904A is fabricated on substrate 902A having branches 906-1, 906-2, 906-3. Further, light sources 908-1, 908-2, 908-3 are provided at a normal incidence. In such embodiments, different branch lengths can create different plasmonic resonances. Thus, ordered nanotrees having branches of multiple lengths can provide a broadband response to a light source. For example, the light sources 908-1, 908-2, 908-3 can each represent different wavelengths of light. Accordingly, applying these light sources at a normal angle to the branches 906-1, 906-2, 906-3, of the ordered nanotrees can generate plasmonic responses in multiple wavelengths (e.g., a broadband response). More specifically, the branch 906-1 may generate a plasmonic response to photons from the light source 906-2; the branch 906-1 may generate a plasmonic response to photons from the light source 906-2; and the branch 906-3 may generate a plasmonic response to photons from the light source 906-3.

FIG. 9B is a diagram of an example sensing application using ordered nanotrees 904B for SERS, in accordance with some embodiments of the present disclosure. As shown, the ordered nanotrees 904B having branch lengths and thicknesses indicated by arrows 910-1, 9102. 910-3 are fabricated on the substrate 902. In contrast to the light sources 908-1, 908-2, 908-3, a light source 908B can provide a wavelength of light at an oblique incidence to branches 910-1. 910-2, 910-3 of the ordered nanotrees 904B. According to some embodiments of the present disclosure, the ordered nanotrees 904B can excite the in-plane and out-of-plane resonances of the branches 906-1, 906-2, 906-3 based on the angle-of-incidence. In this way, the plasmonic response to the array can provide information about a chemical element, compound, molecule, biological molecule, and the like, in the array (e.g., between branches, trunk sections). Conversely to unequal branch lengths, branches of the same length can provide single, relatively sharp, resonances, by multiplying the resonance strength. A single resonance can mean a single frequency with a center and a relatively small broadening. Multiplying the resonance means scattering more photons of light with branches of equal length, thus providing more photons scattered in the same frequencies. Thus, additional branches can increase resonance sharpness by providing more photons scattered at the same frequencies.

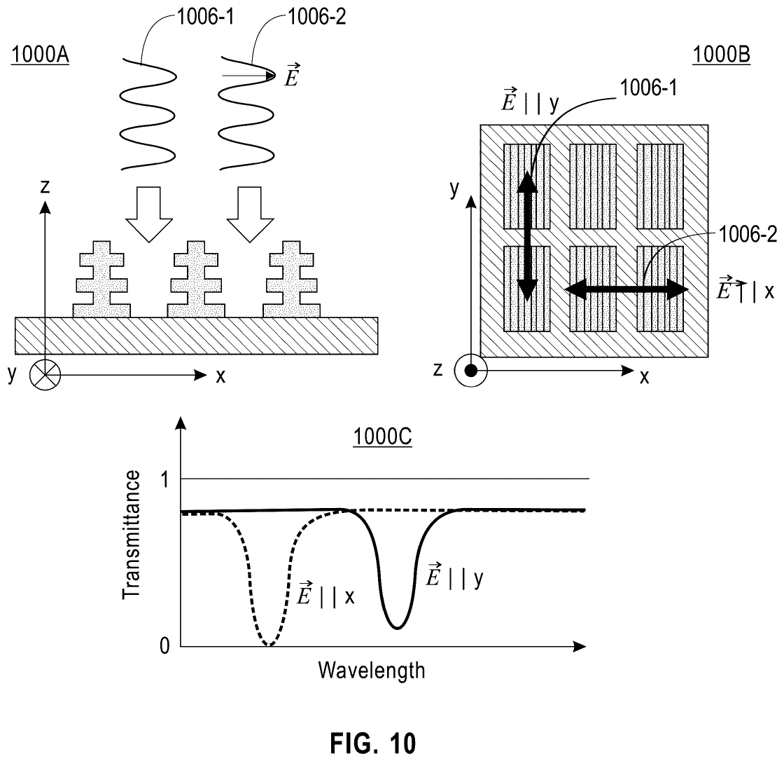

FIG. 10 is a diagram of an example sensing application using example ordered nanotrees 1004, in accordance with some embodiments of the present disclosure. This diagram includes a vertical cross-section view 1000A, a top view 1000B, and a transmittance graph 1000C. In the vertical cross-section view 1000A, the ordered nanotrees 1004B are shown, as fabricated on a substrate 1002. In this example, the substrate 1002 can be a glass material. Accordingly, the light sources 1006-1, 1006-2 can pass through the glass substrate 1002 for the purpose of comparison. Additionally, the vertical cross-section view 1000A, includes x, y, z axis indicators. Thus, in the vertical cross-section view 1000A, the light sources 1006-1, 1006-2 are shown travelling in the z-direction towards the ordered nanotrees 1004, which have branches extending in the x and y directions.

In the top view 1000B, the light source 1006-1 is shown additionally traveling in the y-direction, and the light source 1006-2 is shown additionally traveling in the x-direction. Accordingly, the transmittance graph 1000C shows the energy of transmittance after passing through the glass substrate 1002. More specifically, the line 1008-1 (solid) corresponds to the light source 1006-1, and thus shows the transmittance of the light source 1006-1, travelling in the z and y directions. Additionally, the line 1008-2 corresponds to the light source 1006-2, and thus shows the transmittance of the light source 1006-2 travelling in the x and z directions.

For purposes of this description, certain aspects, advantages, and novel features of the embodiments of this disclosure are described herein. The disclosed processes, and systems should not be construed as being limiting in any way. Instead, the present disclosure is directed toward all novel and nonobvious features and aspects of the various disclosed embodiments, alone and in various combinations and sub-combinations with one another. The processes, and systems are not limited to any specific aspect or feature or combination thereof, nor do the disclosed embodiments require that any one or more specific advantages be present, or problems be solved.

Although the operations of some of the disclosed embodiments are described in a particular, sequential order for convenient presentation, it should be understood that this manner of description encompasses rearrangement, unless a particular ordering is required by specific language set forth below. For example, operations described sequentially can in some cases be rearranged or performed concurrently. Moreover, for the sake of simplicity, the attached figures may not show the various ways in which the disclosed processes can be used in conjunction with other processes. Additionally, the description sometimes uses terms like “provide” or “achieve” to describe the disclosed processes. These terms are high-level abstractions of the actual operations that are performed. The actual operations that correspond to these terms can vary depending on the particular implementation and are readily discernible by one of ordinary skill in the art.

As used in this application and in the claims, the singular forms “a,” “an,” and “the” include the plural forms unless the context clearly dictates otherwise. Additionally, the term “includes” means “comprises.”

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A sensing device comprising:
a substrate; and
an array of ordered nanotrees in contact with the substrate, the array of ordered nanotrees comprising:
a plurality of trunk sections having a corresponding plurality of predetermined trunk thicknesses; and
a plurality of branches having:
a corresponding plurality of predetermined widths in two dimensions; and
a corresponding plurality of predetermined branch thicknesses; and
a corresponding plurality of predetermined distances between two branches of neighboring ordered nanotrees, wherein the array of ordered nanotrees is configured to perform a sensing application based on an interaction between a sensing source and the array of ordered nanotrees.

2. The sensing device of claim 1, wherein the sensing application is a biological sensing application, and wherein the array of ordered nanotrees is configured to capture a biological element between elements of the array of ordered nanotrees based on a selection from a group consisting of the predetermined lengths, predetermined branch thicknesses, and the predetermined trunk thicknesses.

3. The sensing device of claim 1, wherein the sensing application is a surface enhanced Raman scattering.

4. The sensing device of claim 3, wherein the array of ordered nanotrees is configured to enhance a resonance of a light source directed at the array of ordered nanotrees based on the predetermined lengths, predetermined branch thicknesses, or the predetermined branch thicknesses.

5. The sensing device of claim 3, wherein the array of ordered nanotrees is configured to provide a comparison of a light source before scattering off the array and after scattering off the array of ordered nanotrees, wherein the substrate comprises a glass material configured to allow the light source to pass through the substrate.

6. The sensing device of claim 1, wherein the ordered nanotrees comprise round nanotrees.

7. The sensing device of claim 1, wherein the array of ordered nanotrees is configured to provide a broadband response to a light source.

8. A method for fabricating a sensing device, the method comprising:
fabricating a plurality of alternating nanosheet layers comprising a plurality of material compositions, with a plurality of predetermined thicknesses, wherein the plurality of material compositions comprises a plurality of etch properties, and wherein the plurality of etch properties are based on a plurality of predetermined widths, in two dimensions, for an ordered nanotree;
performing a chemical etch on the plurality of alternating nanosheet layers, wherein the single chemical etch generates the ordered nanotree comprising:
a plurality of trunk sections having a first subset of the predetermined widths; and
a plurality of branches having a second subset of the predetermined widths.

9. The method of claim 8, wherein fabricating the plurality of alternating nanosheet layers comprises alternating epitaxial growth of materials of the alternating nanosheet layers, with the plurality of predetermined thicknesses.

10. The method of claim 8, wherein the plurality of alternating nanosheet layers comprise silicon and silicon compounds.

11. The method of claim 10, wherein the silicon compounds are selected from a group consisting of silicon-germanium, silicon-oxide, and silicon-nitride.

12. The method of claim 8, further comprising performing lithography and etching to pattern nanosheet stacks comprising the plurality of alternating nanosheet layers.

13. The method of claim 8, wherein the ordered nanotree excites a plasmonic resonance.

14. The method of claim 8, wherein the ordered nanotree is configured to trap a biomolecule.

15. The method of claim 8, wherein two of the first plurality of predetermined widths are different from each other.

16. The method of claim 8, further comprising:
performing a material fill of the etched plurality of alternating nanosheet layers; and
performing a chemical-mechanical planarization of the etched plurality of alternating nanosheet layers.

17. A sensing device comprising:
a substrate; and
an array of ordered nanotrees in contact with the substrate, the array of ordered nanotrees comprising:
a plurality of trunk sections having a corresponding plurality of predetermined trunk thicknesses; and
a plurality of branches having:
a corresponding plurality of predetermined widths in two dimensions;
a corresponding plurality of predetermined branch thicknesses; and
a corresponding plurality of predetermined distances between branches of neighboring ordered nanotrees, wherein the neighboring ordered nanotrees are configured to excite a plurality of plasmonic resonances, wherein the array of ordered nanotrees is configured to perform a sensing application based on an interaction between a sensing source and the array of ordered nanotrees.

18. The sensing device of claim 17, wherein the sensing application is a surface enhanced Raman scattering.

19. The sensing device of claim 17, wherein the array of ordered nanotrees is configured to provide a comparison of a light source before scattering off the array and after scattering off the array of ordered nanotrees, wherein the substrate comprises a material configured to allow the light source to pass through the substrate.

20. The sensing device of claim 17, wherein the array of ordered nanotrees is configured to provide a broadband response to a light source.
